(19) United States
(12) Patent Application Publication
(10) Pub. No.: US 2024/0133790 A1
(43) Pub. Date: Apr. 25, 2024

(54) DEVICE, IONIC CURRENT MEASUREMENT APPARATUS, ZETA POTENTIAL MEASUREMENT APPARATUS, IONIC CURRENT MEASUREMENT METHOD, AND ZETA POTENTIAL MEASUREMENT METHOD

(71) Applicant: OSAKA UNIVERSITY, Osaka (JP)

(72) Inventors: Makusu TSUTSUI, Osaka (JP); Shohei KISHIMOTO, Osaka (JP); Masateru TANIGUCHI, Osaka (JP)

(21) Appl. No.: 18/547,681

(22) PCT Filed: Feb. 8, 2022
(86) PCT No.: PCT/JP2022/004818

§ 371 Date: Aug. 22, 2023

(30) Foreign Application Priority Data
Feb. 24, 2021 (JP) 2021-026959

(51) Int. Cl. G01N 15/12

(52) U.S. Cl. CPC G01N 15/12

(57) ABSTRACT

An object is to provide a device that can measure a moving time (velocity) of a single particle with high accuracy, and an ion current measuring apparatus and a zeta potential measuring apparatus with the device, and an ion current measuring method and a zeta potential measuring method. The object can be achieved by a device used for measurement of ion current, the device including: a substrate; and a channel formed in the substrate. The channel includes a sample liquid supply channel, a sample collection channel, and constricted channel formed between the sample liquid supply channel and the sample collection channel. The constricted channel includes three or more constricted parts each formed with a protrusion part, the three or more constricted parts are formed substantially straight in a direction from the sample liquid supply channel to the sample collection channel, and when the width of each of the constricted parts is defined as 1, the spacing between adjacent constricted parts is 0.5 to 3.

### TECHNICAL FIELD

The disclosure in the present application relates to a device, an ion current measuring apparatus, a zeta potential measuring apparatus, an ion current measuring method, and a zeta potential measuring method.

### BACKGROUND ART

The zeta potential is known as an index indicating dispersion stability of particles dispersed in a liquid. In recent years, particles have often been used as materials. Since the function of particles can be changed by surface modification, the importance of zeta potentials as indexes indicating stability of surface-modified particles has been increased.

When an electric field is externally applied to a system in which charged particles are dispersed, the particles move toward an electrode. In this movement, since the moving velocity of a particle is proportional to a charge of the particle, it is possible to find the zeta potential by measuring the migration velocity of the particle (see Non-Patent Literature 1). As an example of technologies of measuring a zeta potential, electrophoretic light scattering (ELS) is known. The ELS is called a laser Doppler method, which is a method of finding the migration velocity of a particle by utilizing “Doppler effect” in which, when light or a sound wave hits a moving object and then is reflected or scattered, the frequency of the light or the sound wave changes proportionally to the velocity of the object. More specifically, when a particle in electrophoresis is irradiated with laser light, the frequency of scattered light from the particle is shifted due to the Doppler effect. Since the amount of such a shift is proportional to the migration velocity of the particle, it is possible to find the migration velocity of the particle by measuring the amount of the shift.

As another method of measuring a zeta potential, a resistance pulse measurement method is known, which is to find the zeta potential from a change in pulsed current when a particle passes through a hole (nanopore) formed in a substrate (see Non-Patent Literature 2).

### CITATION LIST

### Non-Patent Literature

Non-Patent Literature 1: Matthias Firnkes et al., “Electrically Facilitated Translocations of Proteins through Silicon Nitride Nanopores: Conjoint and Competitive Action of Diffusion, Electrophoresis, and Electroosmosis”, Nano Letters, 2010, 10(6), pp. 2162-2167.
Non-Patent Literature 2: Nima Arjmandi et al., “Measuring the Electric Charge and Zeta Potential of Nanometer-Sized Objects Using Pyramidal-Shaped Nanopores”, Anal. Chem., 2012, 84, pp. 8490-8496.

### SUMMARY OF INVENTION

### Technical Problem

The ELS described above has a problem of being only capable of measuring an averaged zeta potential of multiple particles contained in a solution, in other words, being incapable of measuring an individual zeta potential of a single particle. In contrast, the art disclosed above in Non-Patent Literature 2 can measure an individual zeta potential of a single particle. However, as a result of extensive study, the inventors have newly found (1) that, by using a device having three or more constricted parts formed that are for measuring a change in ion current when a particle passes therethrough, it is possible to calculate a moving time (velocity) of a single particle with high accuracy and (2) that, further, it is possible to compute a zeta potential of a single particle based on the moving time (velocity) of the single particle obtained by the measurement result.

An object of the disclosure of the present application is to provide a device that can measure a moving time (velocity) of a single particle with high accuracy, an ion current measuring apparatus and a zeta potential measuring apparatus with the device, and an ion current measuring method and a zeta potential measuring method.

### Solution to Problem

The disclosure of the present application relates to a device, an ion current measuring apparatus, a zeta potential measuring apparatus, an ion current measuring method, and a zeta potential measuring method illustrated below.

(1) A device used for measurement of ion current, the device comprising:
a substrate; and
a channel formed in the substrate,
wherein the channel includes
   a sample liquid supply channel,
   a sample collection channel, and
   a constricted channel formed between the sample liquid supply channel and the sample collection channel, wherein
   the constricted channel includes three or more constricted parts each formed with a protrusion part,
   the three or more constricted parts are formed substantially straight in a direction from the sample liquid supply channel to the sample collection channel, and
   when the width of each of the constricted parts is defined as 1, the spacing between adjacent constricted parts is 0.5 to 3.

(2) The device according to (1) above, wherein the width of each of the constricted parts is such a width that allows a single particle contained in a sample liquid to pass through the width but does not allow two or more particles to pass through the width at once.

(3) The device according to (1) or (2) above, wherein all sizes of the constricted parts are the same, and all spacings between the adjacent constricted parts are the same.

(4) An ion current measuring apparatus comprising:
the device according to any one of (1) to (3) above; and
a measuring unit that measures a change in ion current when a particle contained in a sample liquid passes through a constricted channel.

(5) A zeta potential measuring apparatus comprising:
the ion current measuring apparatus according to (4) above; and
a computation unit that calculates a zeta potential of a particle based on a measured ion current value.

(6) The zeta potential measuring apparatus according to (5) above, wherein the computation unit uses a time during which or a velocity at which a particle passes between adjacent constricted parts in the measured ion current value.

(7) The zeta potential measuring apparatus according to (6) above further comprising a storage unit that stores a zeta potential of a reference particle and a time during which or a velocity at which the reference particle passes between the adjacent constricted parts.

(8) An ion current measuring method using an ion current measuring apparatus, wherein the ion current measuring apparatus includes a device and a measuring unit,
wherein the device includes
   a substrate, and
   a channel formed in the substrate,
wherein the channel includes
   a sample liquid supply channel,
   a sample collection channel, and
   a constricted channel formed between the sample liquid supply channel and the sample collection channel, wherein
   the constricted channel includes three or more constricted parts each formed with a protrusion part,
   the three or more constricted parts are formed substantially straight in a direction from the sample liquid supply channel to the sample collection channel,
   when the width of each of the constricted parts is defined as 1, the spacing between adjacent constricted parts is 0.5 to 3, and
wherein the measuring unit is capable of measuring a change in ion current when a particle contained in a sample liquid passes through the constricted channel,
the ion current measuring method comprising:
a particle motion step of causing a particle contained in the sample liquid supplied to the sample liquid supply channel to move toward the sample collection channel; and
a measuring step of measuring a change in ion current when the particle passes through the constricted channel.

(9) A zeta potential measuring method for a sample, the zeta potential measuring method comprising:
a computation step of calculating a zeta potential of a particle based on an ion current value obtained by the ion current measuring method according to (8) above.

(10) The zeta potential measuring method according to (9) above, wherein the computation step uses a time during which or a velocity at which a particle passes between adjacent constricted parts in the measured ion current value.

### Advantageous Effects

The use of the device disclosed in the present application makes it possible to measure a moving time (velocity) of a single particle with high accuracy.

### BRIEF DESCRIPTION OF DRAWINGS

FIG. 1A is a top view of a device 1a according to a first embodiment.

FIG. 1B is a sectional view taken along the arrow X-X of FIG. 1A.

FIG. 1C is a sectional view taken along the arrow Y-Y of FIG. 1A.

FIG. 1D is an enlarged view of a constricted channel 33 part of FIG. 1A.

FIG. 2 is a top view of a device 1b according to a second embodiment.

FIG. 3 is a schematic diagram illustrating an overview of an embodiment of an ion current measuring apparatus 100.

FIG. 4A is a schematic view illustrating a computation unit (computation step) for calculating a zeta potential.

FIG. 4B is a schematic view illustrating a computation unit (computation step) for calculating a zeta potential.

FIG. 5 is a flowchart of an ion current measuring method and a zeta potential measuring method.

FIG. 6 is a photograph substitute for a drawing, which is a photograph of a device (channel formation substrate) manufactured in Example 1.

FIG. 7A(a) is a measured ion current waveform measured in Example 4. FIG. 7A(b) is a waveform after the measured waveform of FIG. 7A(a) is subjected to a fast Fourier transformation (FFT) process and noise removal.

FIG. 7B(c) is a graph illustrating a result after fitting a tₚₚ-m function by an exponential function by using a program. FIG. 7B(d) is a proportional equation for calculating the zeta potential of a measuring target particle.

FIG. 7C(e) is a graph illustrating zeta potentials of calculated individual measuring target particles and the average value obtained by measuring the measuring target particles (Amino-modified PS) by using a commercially available zeta sizer. FIG. 7C(f) is a graph of plots of values of t_{d} instead of tₚₚ.

### DESCRIPTION OF EMBODIMENTS

A device, an ion current measuring apparatus, a zeta potential measuring apparatus, an ion current measuring method, and a zeta potential measuring method will be described below in detail with reference to the drawings.

In the present specification, members having the same type of functions are labeled with the same or similar references. Further, repeated description of the members labeled with the same or similar references may be omitted.

In the present specification, a numerical range expressed by using “to” means a range including numerical values written before and after “to” as the lower limit value and the upper limit value, respectively. Numerical values, numerical ranges, and qualitative expressions (for example, expressions such as “the same/identical”, “substantially/approximately”, or the like) are intended to be interpreted as indicating numerical values, numerical range, and natures including errors tolerated in general in this technical field.

Further, to facilitate understanding, positions, sizes, ranges, or the like of respective configurations indicated in the drawings may not express actual positions, actual sizes, actual ranges, or the like. Thus, the disclosure in the present application is not necessarily limited to positions, sizes, ranges, or the like disclosed in the drawings.

### First Embodiment of Device

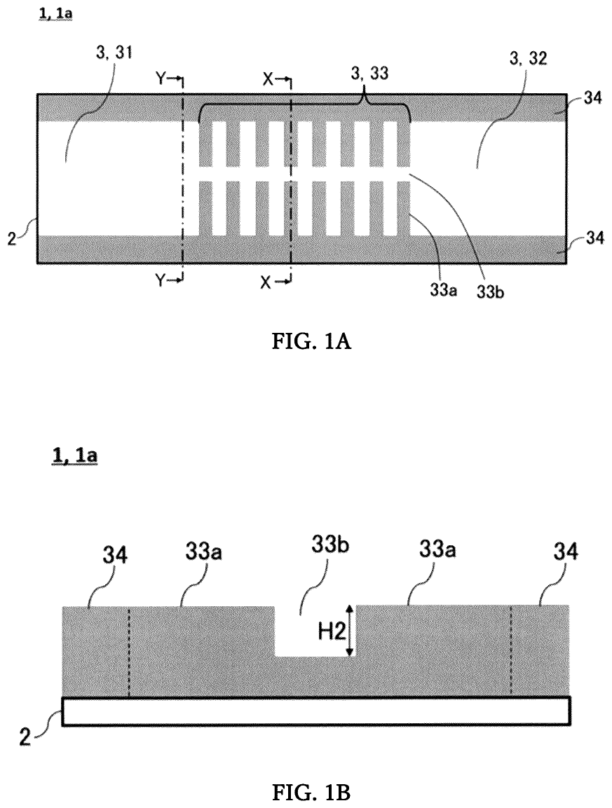

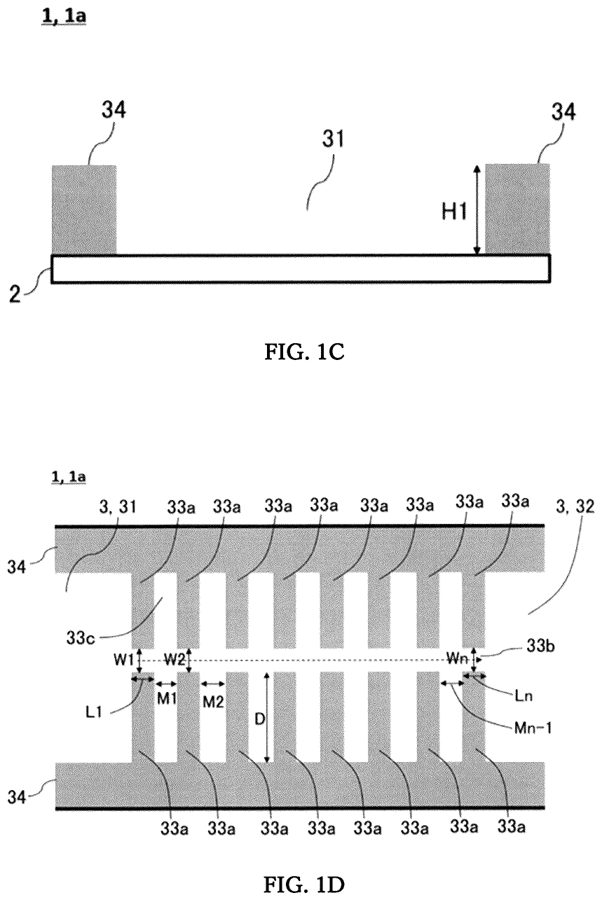

A device 1a according to the first embodiment will be described with reference to FIG. 1A to FIG. 1D. FIG. 1A is a top view of the device 1a, FIG. 1B is a sectional view taken along the arrow X-X of FIG. 1A, FIG. 1C is a sectional view taken along the arrow Y-Y of FIG. 1A, and FIG. 1D is an enlarged view of a constricted channel 33 part of FIG. 1A.

The device 1a includes a substrate 2 and a channel 3 formed in the substrate 2. The channel 3 includes a sample liquid supply channel 31, a sample collection channel 32, and a constricted channel 33 formed between the sample liquid supply channel 31 and the sample collection channel 32. The constricted channel 33 includes three or more constricted parts 33b defined using protrusion parts 33a.

The device 1a can be manufactured by using a microfabrication technology, for example. An example of the procedure is illustrated below.

(1) An etchable material such as Cr is applied onto the substrate 2 by chemical deposition.
(2) A positive type photoresist is applied by a spin coater.
(3) A photomask is used for performing exposure and development processes so that a portion where a channel is to be formed is irradiated with light, and the positive type photoresist on the portion where the channel is to be formed is removed. At this time, the shape of the photomask can be changed so that the channel 3 is arranged as desired.
(4) The exposed etchable material of (1) is removed.
(5) The exposed substrate 2 is shaved off by some method such as reactive etching or focused ion beam (FIB) to form the channel 3.

Note that the above procedure is an example of forming the channel 3 by shaving off the substrate 2. Alternatively, the channel 3 may be formed by depositing a resist or the like on the substrate 2 and shaving off the deposited resist or the like by etching. FIG. 1A to FIG. 1D illustrate an example in which the channel 3 is formed by using a resist or the like deposited on the substrate 2. In the present specification, “channel formed in a substrate” includes both of an embodiment in which the channel 3 is formed by shaving off the substrate 2 and an embodiment in which the channel 3 is formed in a material such as a resist deposited on the substrate 2.

The substrate 2 is not particularly limited as long as it is made of a material generally used in the field of semiconductor manufacturing technologies. The material of the substrate 2 may be, for example, Si, SiOₓ, SiNₓ, Ge, Se, Te, GaAs, GaP, GaN, InSb, InP, or the like.

The reagents used for the positive type photoresist, development, etching, and the like are not particularly limited as long as they are materials generally used in the field of microfabrication technologies. Further, the spin coater and the apparatus used for etching or the like are also not particularly limited as long as they are apparatuses generally used in the field of microfabrication technologies.

The device 1a manufactured by the above manufacturing method and the device 1a illustrated in FIG. 1A to FIG. 1D each are a mere example. A negative type photoresist may be used instead of the positive type photoresist. Further, the device 1a may be manufactured by first fabricating a mold by using a microfabrication technology and then transferring a material such as PDMS to the mold. Alternatively, the device 1a may be manufactured by using a 3D printer.

In the example illustrated in FIG. 1A to FIG. 1D, the constricted part 33b is defined by a pair of protrusion parts 33a formed to the channel wall 34. In example illustrated in FIG. 1A to FIG. 1D, it can be said that the width W of each constricted part 33b is a clearance between a pair of protrusion parts 33a arranged facing each other. The width W of the constricted part 33b is such a width that allows a single particle included in a sample liquid to pass therethrough but does not allow two or more particles to pass therethrough at once. Note that, in the present specification, “sample liquid” means a liquid in which particles that are measuring targets are dispersed. The liquid in which particles are dispersed may be an electrolytic solution described later.

The particle is not particularly limited as long as it has a volume and is charged in a liquid. The particle may be, for example, a biological substance such as a bacterium, a cell, a virus, DNA, RNA, a protein, a pollen, or the like; a nonbiological substance such as a sulfur oxide (SOx), a nitrogen oxide (NOx), a volatile organic compound (VOC), an oxidized mineral (silicon, aluminum, titanium, iron, or the like), a resin bead, or the like; or the like.

Since the sensitivity when a particle passes through the constricted part 33b will be higher for a smaller volume of the constricted part 33b, the constricted part 33b can be such a size that allows a single particle, which is a measuring target, to pass therethrough but does not allow two or more particles to pass therethrough at once. For example, a pollen of cedar and cypress sizes about 30 μm to 40 μm, the average size of human cells sizes about 20 μm, a mold sizes about 2 μm to 10 μm, a bacterium sizes about 1 μm to 5 μm, and a virus sizes about 20 nm to 300 nm. The upper limit of the width W of the constricted part 33b can be, for example, but is not limited to, 80 μm or less, 60 μm or less, 40 μm or less, 20 μm or less, 10 μm or less, 1000 nm or less, 800 nm or less, 600 nm or less, 400 nm or less, 200 nm or less, 150 nm or less, or 100 nm or less. On the other hand, while the lower limit of the width W of the constricted part 33b is not particularly limited in terms of measurement of ion current, the width W of the constricted part 33b can be 10 nm or greater, 15 nm or greater, 20 nm or greater, 25 nm or greater, or 30 nm or greater in terms of accurately fabricating a plurality of constricted parts 33b.

The length L of the constricted part 33b may be shorter or longer than a measuring target particle, and the sensitivity will be higher for a shorter length L. The length L can be set as appropriate so that a desired sensitivity is obtained. When the width W of the constricted part 33b is defined as 1, the length L of the constricted part 33b can be, for example, but is not limited to, 20 or less, 18 or less, 16 or less, 14 or less, 12 or less, 10 or less, 8 or less, 6 or less, 5 or less, 4 or less, 3 or less, 2 or less, 1 or less, 0.8 or less, 0.6 or less, 0.4 or less, 0.2 or less, or 0.1 or less. On the other hand, while the lower limit of the length L of the constricted part 33b is not particularly limited in terms of measurement of ion current, the length L of the constricted part 33b can be 10 nm or greater, 15 nm or greater, 20 nm or greater, 25 nm or greater, or 30 nm or greater in an absolute value in terms of accurately fabricating a plurality of constricted parts 33b.

The depth H2 of the constricted part 33b (see FIG. 1B) is not particularly limited as long as it is such a size that allows a single measuring target particle to pass therethrough but does not allow two or more particles to pass therethrough at once. The depth H2 of the constricted part 33b may take the same range as the range that the width W may take, though not limited thereto. Note that the depth H2 of the constricted part 33b may be the same as or different from the width W.

The device 1a according to the first embodiment is characterized in that three or more constricted parts 33b are formed in the constricted channel 33 and these three or more constricted parts 33b are formed substantially straight in the direction from the sample liquid supply channel 31 to the sample collection channel 32. While described in detail later, the moving time during which a particle moves between adjacent constricted parts 33b when the particle passes through the constricted channel 33 of the device 1a becomes more stable as the particle comes closer to the sample collection channel 32 side. By using the stabilized moving time, it is possible to compute a zeta potential, for example. Therefore, the number of constricted parts 33b can be at least three or greater (n=an integer of three or greater). In other words, there can be two or more places to measure the moving time of a particle. The number of constricted parts 33b may be four or greater or five or greater.

On the other hand, while the upper limit of the number of constricted parts 33b is not particularly limited in terms of the capability of calculating the stable moving time (velocity) of a particle, a larger number of constricted parts 33b results in an increased size and increased cost of the device 1a. Therefore, the upper limit of the number of constricted parts 33b may be provided in terms of the size or the cost of the device 1a instead of a technical point of view and may be, for example, 30 or less (n=an integer of 30 or less), 25 or less, 20 or less, 15 or less, 10 or less, 9 or less, 8 or less, 7 or less, 6 or less, 5 or less, or 4 or less.

The device 1a disclosed in the present application can be used for measurement of a particle moving time used for computing a zeta potential. In such a case, based on a waveform when the particle passes through the constricted parts 33b, it is possible to calculate the moving velocity of a particle based on the width W of the constricted part 33b of the device 1a used in measurement and the measured moving time even when the widths W of the constricted parts 33b differ from each other. Therefore, the sizes of the three or more constricted parts 33b, in other words, the widths W are not required to be the same for all the constricted parts 33b and may differ from each other. Similarly, the lengths L of the constricted parts 33 may be the same or different from each other. On the other hand, with the use of the device 1a disclosed in the present application, it is possible to measure three or more changes in ion current at once when a single particle passes through the three or more constricted parts 33b. When the number of particles contained in a sample liquid is small, it is useful to compare multiple measurement data for the same condition in a single time of measurement in analyzing measurement results. Therefore, the sizes (W, L, H) of all the three or more constricted parts 33b may be the same but is not limited thereto.

To stabilize the trajectory when a particle moves, it is preferable to design the channel so that a particle can flow straight. In the present specification, the expression “three or more constricted parts 33b are formed substantially straight in the direction from the sample liquid supply channel 31 to the sample collection channel 32” means that a line connecting intermediate points of the widths of the constricted parts 33b (W1, W2, . . . , Wn) is substantially straight, as illustrated in FIG. 1D.

In the example illustrated in FIG. 1D, when the width W of the constricted part 33b is defined as 1, it is desirable that the spacing M between adjacent constricted parts 33b (hereafter, which may be simply referred to as “spacing M”) be 0.5 to 3. With an excessively short spacing M, two constricted parts 33b adjacent to each other would work as if they were a single constricted part, which would make it difficult to analyze a measured ion current waveform. Therefore, when the width W of the constricted part 33b is defined as 1, the spacing M between adjacent constricted parts 33b (the spacing between the protrusion parts 33a) can be, but is not limited to, for example, 0.5 or greater, 0.6 or greater, 0.7 or greater, 0.8 or greater, 0.9 or greater, or 1 or greater.

In contrast, with an excessively large spacing M, the amount of a liquid filled in a groove 33c defined between the protrusion parts 33a would increase. The Brownian motion occurs in the liquid. Therefore, the larger the spacing M is, the more the particle passing between the constricted parts 33b is likely to be affected by the Brownian motion. As a result, the trajectory on which a particle moves becomes unstable, and this affects stability of the measured moving time of the particle (the moving velocity of the particle when moving through a predetermined spacing). Therefore, when the width W of the constricted part 33b is defined as 1, the spacing M (the spacing between the protrusion parts 33a) can be, but is not limited to, for example, 3 or less, 2.8 or less, 2.6 or less, 2.4 or less, 2.2 or less, 2.0 or less, 1.8 or less, 1.6 or less, 1.4 or less, 1.2 or less, 1.0 or less, or the like.

Note that, if the length D of the groove 33c (the length of the protrusion part 33a from the channel wall 34) were 0, no constricted part 33b would be defined. In contrast, an excessively large groove 33c would increase the size of the device 1a. Therefore, the length D of the groove 33c can be adjusted as appropriate taking into consideration the measurement sensitivity of ion current of a particle passing through the constricted part 33b.

The spacings M may be all the same or different from each other. Based on the waveform when a particle passes through the constricted parts 33b, it is possible to verify which portion of the constricted parts 33b the particle passes through. Therefore, when the spacings M differ from each other, the moving velocity of a particle can be calculated based on the lengths of the spacings M. However, since the same spacing M of the constricted parts 33b improves convenience in a computation step, the spacings M may be all the same in terms of efficiency instead of a technical point of view.

In the example illustrated in FIG. 1B and FIG. 1C, the depth H1 of the sample liquid supply channel 31 of the device 1a is deeper than the depth H2 of the constricted channel 33. Further, while depiction is omitted, the depth of the sample collection channel 32 may also be deeper than the depth H2 of the constricted channel 33. It is preferable to reduce the resistance related to the channel 3 in order to increase measurement sensitivity in measuring a change in ion current when a particle passes through the constricted part 33b. The resistance of a channel filled with a liquid is a value obtained by dividing a product of resistance rate of the liquid and a length of the channel by the sectional area of the channel. As described above, the smaller the constricted part 33b is, the higher the measurement sensitivity will be. Thus, when the sample liquid supply channel 31 and the sample collection channel 32 are much deeper than the constricted channel 33, the resistance can be reduced to improve the measurement sensitivity. Further, because a level difference is formed between the constricted channel 33 and the sample liquid supply channel 31, a particle flows more smoothly in the constricted channel 33 when an electric field is applied so as to interpose the constricted channel 33.

Note that the example illustrated in FIG. 1B and FIG. 1C merely represents a preferred embodiment and is not an essential feature for the device 1a disclosed in the present application. The depth of the sample liquid supply channel 31 and the sample collection channel 32 may be the same as the depth of the constricted channel 33, or the depth of either the sample liquid supply channel 31 or the sample collection channel 32 may be deeper than the depth of the constructed channel 33.

### Second Embodiment of Device

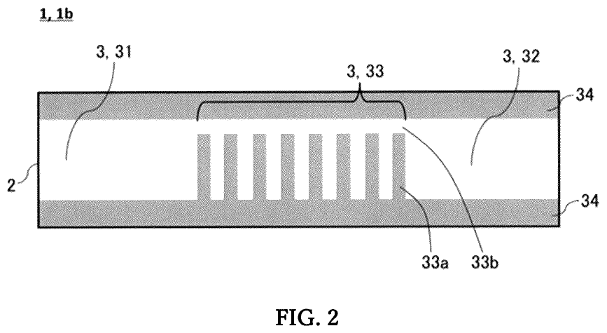

A device 1b according to the second embodiment will be described with reference to FIG. 2. FIG. 2 is a top view of the device 1b. Note that the device 1b according to the second embodiment is the same as the device 1a according to the first embodiment except that each constricted part 33b is formed of a single protrusion part 33a and the channel wall 34. Thus, in the second embodiment, differences in constricted part 33b will be mainly described, and repeated description for the features already described in the first embodiment will be omitted. Thus, obviously, the feature already described in the first embodiment can be employed in the second embodiment even when not explicitly described therein.

The device 1b illustrated in FIG. 2 is the same as the device 1a according to the first embodiment except that each constricted part 33b is formed of a single protrusion part 34 and the channel wall 34. The device 1b according to the second embodiment achieves the same advantageous effects as the device 1a according to the first embodiment.

### Modified Example of Device 1

It is apparent that the device 1 disclosed in the present application is not limited to those in the first and second embodiments described above and can be modified or changed as appropriate within the scope of the technical concept disclosed in the present application. Further, any component can be omitted in each embodiment.

For example, the manufactured device 1 may be subjected to hydrophilization treatment in order to cause a sample liquid to flow more smoothly. The hydrophilization treatment method may be plasma treatment, surfactant treatment, polyvinyl pyrrolidone (PVP) treatment, photocatalyst treatment, SiO₂ film coating, or the like. For example, the surface on which the channel 3 of the device 1 is formed is subjected to plasma treatment for 10 to 30 seconds, and thereby a hydroxy group can be introduced to the surface. Further, a cover member having a size covering at least the constricted channel 33 may be attached to the device 1. Alternatively, a cover member having holes formed therein to supply and collect a sample liquid and having substantially the same shape as the substrate 2 may be attached to the device 1. Further, electrodes for applying a voltage may be formed to the sample liquid supply channel 31 and the sample collection channel 32 of the device 1. Further, as illustrated in a photograph of a device manufactured by Examples described later, the sample liquid supply channel 31 and the sample collection channel 32 may be partitioned from each other by a partition.

### Embodiment of Ion Current Measuring Apparatus

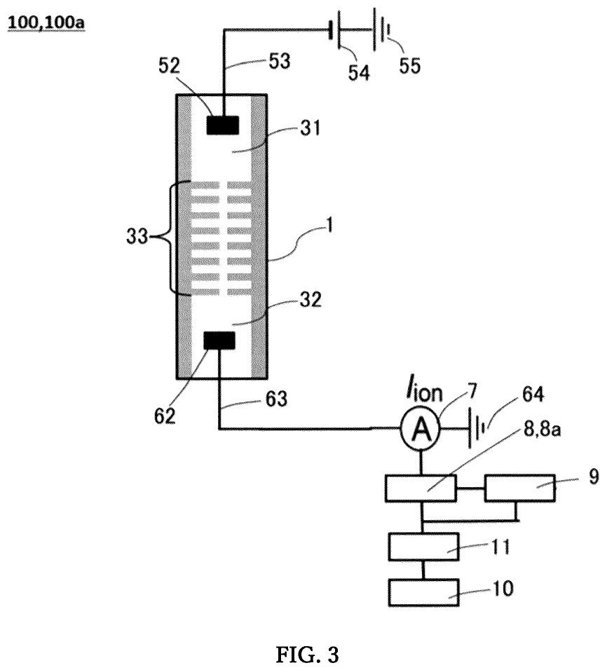

An embodiment of an ion current measuring apparatus will be described with reference to FIG. 3. FIG. 3 is a schematic diagram illustrating an overview of the embodiment of an ion current measuring apparatus 100. The ion current measuring apparatus 100 includes, in addition to the device 1, a measuring unit 7 that measures a change in ion current when a particle contained in a sample liquid passes through the constricted channel 33 of the device 1.

In the example illustrated in FIG. 3, a first electrode 52 is formed at a portion in contact with the sample liquid inside the sample liquid supply channel 31, and a second electrode 62 is formed at a portion in contact with the sample liquid inside the sample collection channel 32. The first electrode 52 and the second electrode 62 may be components of the device 1 or may be components of the ion current measuring apparatus 100.

Further, the ion current measuring apparatus 100 may optionally include an analysis unit 8 that analyzes ion current measured by the measuring unit 7, a display unit 9 that displays a measured ion current value and/or a result of analysis made by the analysis unit 8, a program memory 10 that stores a program in advance that causes the analysis unit 8 or the display unit 9 to function, and a control unit 11 that reads and executes the program stored in the program memory 10. The program may be stored in the program memory 10 in advance or may be stored in a storage medium and then stored in the program memory 10 by the use of installing means.

The first electrode 52 and the second electrode 62 can be formed of a known conductive metal such as aluminum, copper, platinum, gold, silver, titanium, or the like. The first electrode 52 and the second electrode 62 may be formed on the substrate 2 or may be prepared as a component separate from the device 1 and inserted through a hole of a cover member provided where necessary.

The first electrode 52 is connected to a power supply 54 and an earth ground 55 via a lead 53. The second electrode 62 is connected to the measuring unit 7 and an earth ground 64 via a lead 63. Note that, although the power supply 54 is connected to the first electrode 52 side and the measuring unit 7 is connected to the second electrode 62 side in the example illustrated in FIG. 3, the power supply 54 and the measuring unit 7 may be provided on the same electrode side.

The power supply 54 is not particularly limited as long as it can conduct direct current to the first electrode 52 and the second electrode 62. The measuring unit 7 is not particularly limited as long as it can measure ion current occurring over time when the first electrode 52 and the second electrode 62 are electrically conducted. For example, the measuring unit 7 is an ammeter. Note that, although not illustrated in FIG. 3, a noise removal circuit, a voltage stabilizing circuit, or the like may be provided where necessary.

When a particle is located in the constricted part 33b, ion current flowing in the constricted part 33b is blocked by the particle, and the ion current value measured by the measuring unit 7 is reduced. The amount of such a reduction in ion current is proportional to the volume of the particle in the constricted part 33b.

The analysis unit 8 analyzes an ion current value measured by the measuring unit 7. As described above, the ion current value varies in accordance with the size of a particle. It is therefore possible to identify a particle by performing data analysis by the analysis unit 8 based on the measured ion current value.

The display unit 9 may be any display unit that can display a measured ion current value (a graph illustrating a change) or a result of analysis made by the analysis unit 8 and can be a known display apparatus such as a liquid crystal display, a plasma display, an organic EL display, or the like.

### Embodiment of Zeta Potential Measuring Apparatus

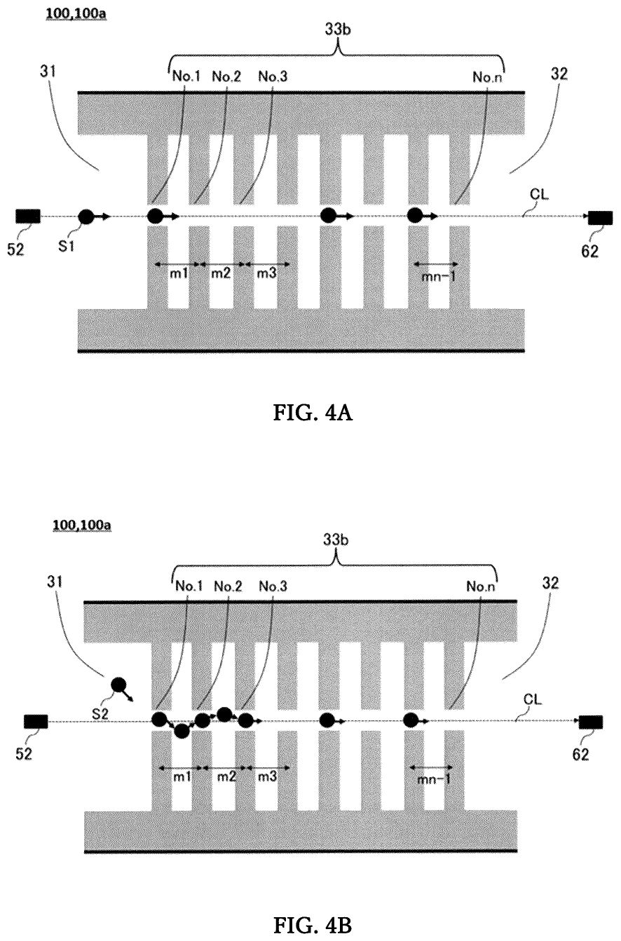

An embodiment of a zeta potential measuring apparatus 100a and a zeta potential measuring method will be described with reference to FIG. 3, FIG. 4A, and FIG. 4B. FIG. 4A and FIG. 4B are schematic diagrams illustrating a computation unit (computation step) to calculate a zeta potential. The zeta potential measuring apparatus 100a includes the ion current measuring apparatus 100 and a computation unit 8a that calculates a zeta potential of a particle based on an ion current value measured by the ion current measuring apparatus 100. In the example illustrated in FIG. 3, the analysis unit 8 that is an optional additional component in the ion current measuring apparatus 100 is an essential component and also used as the computation unit 8a that calculates a zeta potential. Alternatively, although depiction is omitted, the analysis unit 8 may be an optional additional component, and the computation unit 8a that calculates a zeta potential may be provided in the zeta potential measuring apparatus 100a.

As illustrated in FIG. 4A, a voltage is applied across the first electrode 52 arranged in the sample liquid supply channel 31 and the second electrode 62 arranged in the sample collection channel 32. In response, a charged particle S1 moves from the sample liquid supply channel 31 toward the sample collection channel 32. FIG. 4A illustrates an example in which the particle S1 enters the constricted channel 33 from the sample liquid supply channel 31 along the center line CL of the constricted channel 33. In such a case, since the particle S1 travels straight on the center line CL, the time during which the particle travels between the constricted parts 33b (in the example illustrated in FIG. 4A, the distance between the intermediate points of adjacent constricted parts 33b: m1, m2, m3, . . . , mn−1) is the same for all m1, m2, m3, . . . , mn−1.

On the other hand, the inventors analyzed ion current measured by using the device 1 manufactured so that the distances m1, m2, m3, . . . , mn−1 are the same, as illustrated in Example described later. In accordance with analysis of the measured ion current values, however, it was newly found that the moving time of a particle is longer (the moving velocity is slower) on the inlet side of the constricted channel 33 (for example, m1, m2).

The following reasons can be considered as the cause of the above.

(1) As illustrated in FIG. 4B, the sample liquid supply channel 31 is formed larger than the constricted channel 33.
(2) Thus, a particle S2 dispersed in the sample liquid supply channel 31 enters the constricted channel 33 from a direction different from the center line CL of the constricted channel 33 more often.
(3) In such a case, even after entering the constricted channel 33 due to the kinetic energy of the particle S2, the particle S2 travels off the center line CL. Thus, the particle S2 travels diagonally across the first constricted part 33b No. 1, and therefore, the distance of motion in the constricted part 33b No. 1 is longer than when the particle travels along the center line CL. Further, the distance of motion between the constructed parts 33b No. 1 and No. 2 is also longer than when the particle travels along the center line CL.
(4) In contrast, since the first electrode 52 and the second electrode 62 are electrically conducted, pushing force that forces the particle S2 to move along the center line CL has occurred in the constricted channel 33.
(5) Thus, as the particle S2 travels in the constricted channel 33, a deviation of the particle S2 from the center line CL occurring when the particle S2 enters the constricted channel 33 is converged by the pushing force. As a result, the particle S2 that has entered the constricted channel 33 travels along the center line CL after a predetermined convergence period.

Based on the novel finding described above, the computation unit 8a calculates a zeta potential by using the time during which or the velocity at which the particle S2 passes between adjacent constricted parts 33b in the measured ion current values.

More specifically, the computation unit 8a calculates the time during which or the velocity at which a particle moves between the constricted parts 33b (m1, m2, m3, . . . , mn−1) based on a waveform of measured ion current values (in the following description, the time during which or the velocity at which the particle S2 moves through “m1” may be denoted as “tm1” or the like. Further, when any of “time” and “velocity” where a particle moves is useful, an expression of “time or the like” will be used). Note that, when the ion current measuring apparatus 100 has the analysis unit 8, the process of the analysis unit 8 instead of the process of the computation unit 8a may be responsible for the time or the like where the particle S2 moves.

Next, the computation unit 8a calculates a time or the like used for computation that is for calculating a zeta potential based on the calculated moving time or the like of the particle S2. An example of calculating the time or the like used for computation will be described below.

(1) All tm1, tm2, tm3, tmn−1 are used to perform fitting by an exponential function, and an intercept of the obtained approximate curve is calculated and defined as the time or the like used for computation.
(2) Except for at least tm1 at which the moving time or the like of a particle is unstable, tm2, tm3, tmn−1 are used, and an intercept is calculated and defined as the time or the like used for computation in the same manner as (1) described above.
(3) Except for at least tm1 at which the moving time or the like of a particle is unstable, an average value of any moving time or the like selected from tm2, tm3, tmn−1 is calculated and defined as the time or the like used for computation.
(4) The moving time or the like of tmn−1 at which the moving time or the like of a particle is stable is defined as the time or the like for computation.

Note that the method of calculating a time or the like used for computation described in (1) to (4) above is a mere example, and other methods may be employed as long as a reliable moving time (velocity) of the particle S2 can be calculated. Further, when tm1 is not used for calculation of the time or the like used for computation, L1 of the first constricted part 33b on the sample liquid supply channel side may be increased. An increase of the length of the first constricted part 33b, which is not used for calculation of the time or the like used for computation, facilitates a particle moving in the constricted channel 33 to travel along the center line CL.

Since the moving time or the like of the particle S2 is proportional to a charge of a particle as disclosed in Non-Patent Literature 1, the moving time or the like and the zeta potential of the particle S2 have a correlation therebetween. Therefore, also for a particle whose zeta potential is known (a reference particle), it is possible to calculate a moving time or the like in the same manner as for the particle S2 and calculate the zeta potential of the particle S2 based on a ratio of the moving times or the like of the particle S2 and the reference particle.

Although depiction is omitted, the zeta potential measuring apparatus 100a may further include a storage unit that stores a zeta potential of a reference particle and a moving time or the like where the reference particle passes between adjacent constricted parts. When the zeta potential measuring apparatus 100a further includes the storage unit, the computation unit 8a can omit measurement of the moving time or the like of a reference particle and calculate the zeta potential of the particle S2 based on the zeta potential and the moving time or the like of the reference particle stored in the storage unit. This can improve convenience in measurement of the zeta potential of the particle S2.

### Embodiment of Ion Current Measuring Method and Zeta Potential Measuring Method

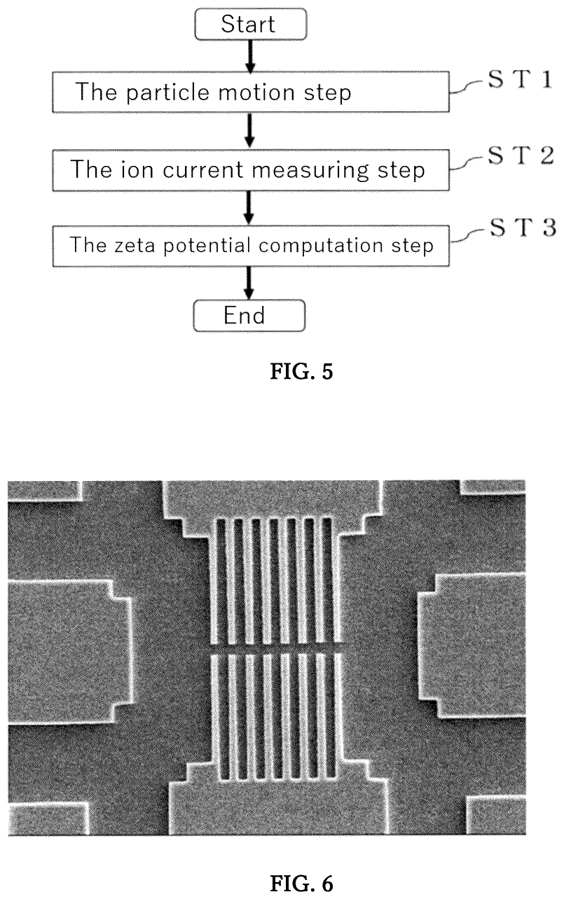

Next, an ion current measuring method using the ion current measuring apparatus 100 and a zeta potential measuring method using the zeta potential measuring apparatus 100a will be described with reference to FIG. 5. FIG. 5 is a flowchart of the ion current measuring method and the zeta potential measuring method. The embodiment of the ion current measuring method includes a particle motion step (ST1) and an ion current measuring step (ST2). The embodiment of the zeta potential measuring method includes a zeta potential computation step (ST3) in addition to the particle motion step (ST1) and the ion current measuring step (ST2).

The particle motion step (ST1) is implemented by supplying a sample liquid to the sample liquid supply channel 31, supplying an electrolytic solution to the sample collection channel 32, and applying a voltage across the first electrode 52 and the second electrode 62. The electrolytic solution is not particularly limited as long as the first electrode 52 and the second electrode 62 can be electrically conducted with each other, and a TE buffer, a PBS buffer, a HEPES buffer, a KCl aqueous solution, or the like may be used. In this step, the sample liquid supply channel 31 and the sample collection channel 32 are in fluid communication via the constricted channel 33 due to a capillary action. Since the particle carries a surface charge, in response to application of a voltage across the first electrode 52 and the second electrode 62, the particle enters the constricted channel 33 from the sample liquid supply channel 31 and reaches the sample collection channel 32 while passing through the constricted parts 33b.

In the ion current measuring step (ST2), the value of ion current occurring due to electrical conduction to the first electrode 52 and the second electrode 62 is measured over time by the measuring unit 7.

In the computation step, the zeta potential of the particle is calculated by the method described above (in the embodiment of the zeta potential measuring apparatus) based on the ion current value obtained in the ion current measuring step (ST2). Note that the particle motion step (ST1) and the ion current measuring step (ST2) may be implemented also for a reference particle before the zeta potential computation step (ST3) where necessary.

Although Examples will be presented below to specifically describe the present invention, these Examples are provided for mere illustration of the present invention and for reference to the specific form thereof. These illustrated examples are for describing particular specific forms of the present invention but are intended neither to limit the scope of the invention disclosed in the present application nor to express limitation of the same.

### EXAMPLE

### Example 1

### <<Manufacturing of Device>>

### Channel Formation Substrate

An Si wafer having a thickness of 400 μm was cut into small pieces of 25 mm square by cleavage. Next, a Cr thin film was deposited by high-frequency magnetron sputtering. A pattern of a channel was then drawn on the upper surface of each of the small pieces by typical electron beam lithography using a ZEP 520A positive type resist, and an exposed Cr layer was removed by wet etching. The resulting exposed Si surface was shaved off by deep reactive ion etching to fabricate a micro-channel. Finally, the whole surface of the channel was covered with a SiO₂ film having a thickness of 50 nm by chemical deposition.

FIG. 6 is a photograph of a fabricated device (channel formation substrate). The overview of the fabricated device will be described with reference to the reference symbols in FIG. 1A to FIG. 1D. Eight constricted parts 33b were formed in the constricted channel 33, the width of each constricted part 33b (W1 to W8) was 550 nm, the length thereof was 600 nm, and the depth H2 thereof was 500 nm. Further, the spacing between the constricted parts 33b (M1 to M7) was 600 nm. The length D of the groove 33c was 600 nm. Further, the depth H1 of the sample liquid supply channel 31 and the sample collection channel 32 was 500 nm.

### Cover Member and Adhesion

A cover member was fabricated with polydimethylsiloxane (PDMS). Note that, to inject a phosphate buffer solution (sample liquid) containing particles into the sample liquid supply channel 31, a millimeter-scaled groove was fabricated in advance in a PDMS block (fabricated by preparing a protruding pattern made of SU-8 on the Si wafer by photolithography and using this as a mold to heat and cure the PDMS at 80° C.). The PDMS block was then cut out by a knife. Subsequently, the adhering surface of the PDMS and the channel formation substrate were subjected to oxygen plasma treatment and thereby activated, and both the faces were immediately attached to each other to be adhered. Note that adhesion was performed while alignment between the groove of the PDMS and the channel pattern on the Si substrate were being performed under an optical microscope. Eight holes were perforated in the PDMS block, two out of which were used for arranging Ag/AgCl electrodes for ion current measurement therein, and the remaining six were used as injection port for injecting a solution including dispersed measuring target particles into the micro-channel.

### Example 2

### Manufacturing of Ion Current Measuring Apparatus

A pair of Ag/AgCl electrodes were used as the first electrode 52 and the second electrode 62. A bias power supply (AXISNET) driven by a battery was used as the power supply 54 and connected to the first electrode 52 via a lead. A current amplifier and a digitizer having a high time-resolution at 1 MHz (NI5922, National Instruments) were used for the measuring unit 7 to acquire data, and the acquired data was stored in an SDD (NI 8260, National Instruments Co.)

### Example 3

### Ion Current Measuring Method

### (1) Fabrication of Sample Liquid

Amino group-modified polystyrene particles (#07763 by Polysciences) each having a diameter of 460 μm were used as measuring target particles and carboxyl group-modified polystyrene particles (#09836 by Polysciences) each having a diameter of 489 μm were used as reference particles. The particles were suspended in a PBS buffer solution (NaCl 137 mM) to have a concentration of 3.6×10¹¹ particles/ml, and thereby the sample liquid was fabricated.

### (2) Measurement of Ion Current

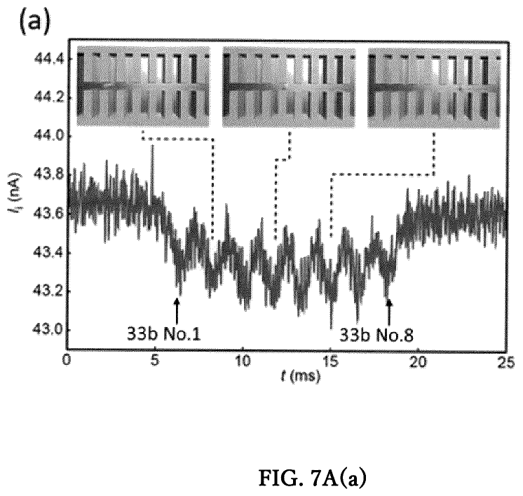

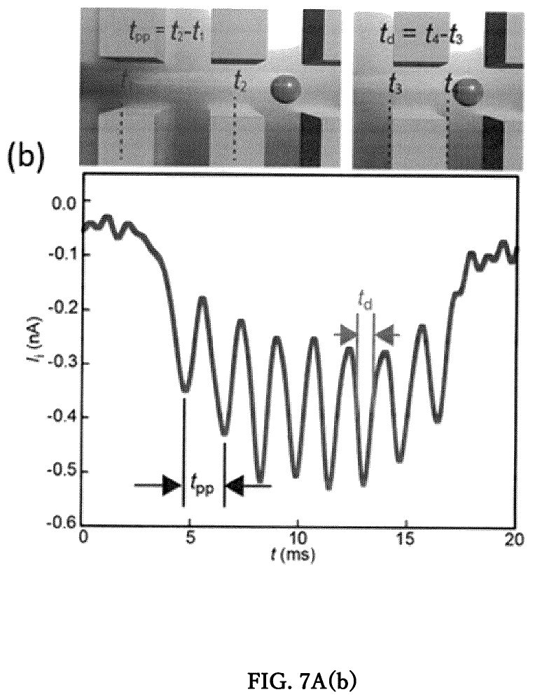

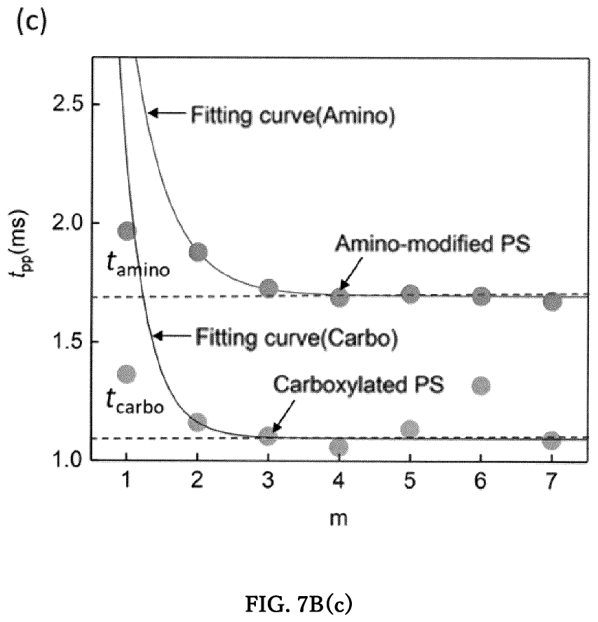

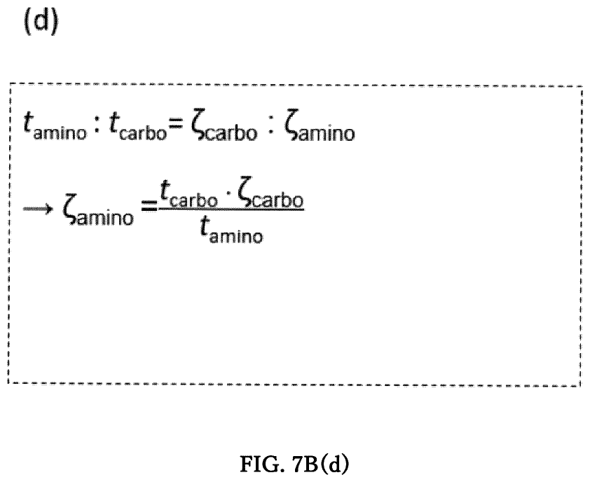

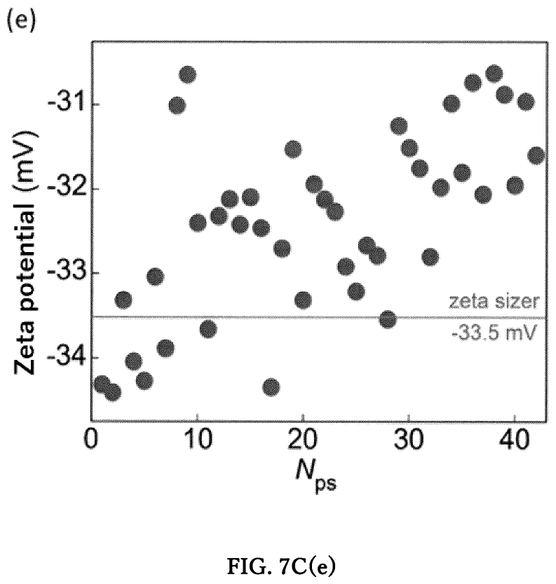

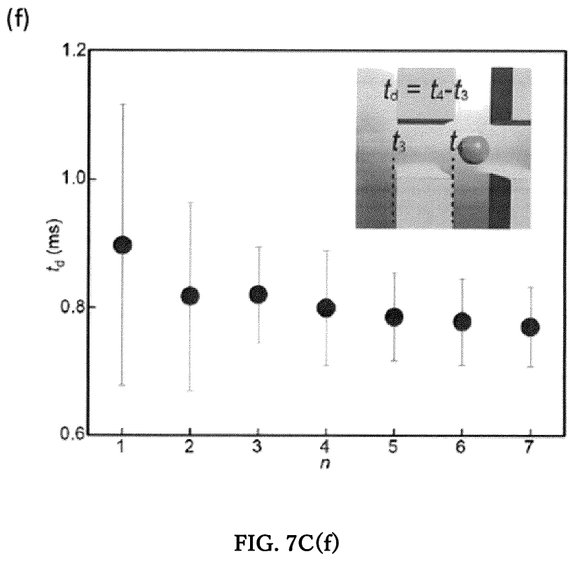

The sample liquid fabricated in (1) described above was supplied into the sample liquid supply channel, and the PBS buffer solution was supplied into the sample collection channel. A direct voltage 1 V was applied to one of the electrodes, and current flowing into the other electrode was amplified by a current amplifier and stored in an HDD via a high-speed digitizer (NI5922, National Instruments Inc.) at a sampling rate of 1 MHz. FIG. 7A(a) illustrates the measured ion current waveform. As illustrated in FIG. 7A(a), changes in the ion current when the particle passes through the eight constricted parts 33b were measured.

### Example 4

### Manufacturing of Zeta Potential Measuring Apparatus and Zeta Potential Measuring Method

A zeta potential measuring apparatus was manufactured by adding a computation unit that performs computation of (1) to (5) described below to the ion current measuring apparatus, and zeta potentials were calculated.

(1) A fast Fourier transformation (FFT) process was performed on the measured ion current waveform of FIG. 7A(a) to remove noise. FIG. 7A(b) illustrates the waveform after the FFT process. Note that, in general, a measurement value of ion current exhibits the smallest value when a particle passes through the center portion of the constricted part 33b (see arrows of [33b No. 1] and [33b No. 8] in FIG. 7A(a), for example). Therefore, since process (2) illustrated below can also be performed directly based on a measured ion current waveform, the FFT process is an optional additional process (step) and is not an essential process (step) of the computation unit.
(2) The moving time of a particle was calculated based on the ion current waveform. FIG. 7A(b) illustrates an example in which a time (tₚₚ) during which a particle travels between the centers of adjacent constricted parts 33b was calculated. As described in (1) above, a peak value in the downward direction of the measured ion current value corresponds to a time when a particle passes through the center of the constricted part 33b. Therefore, the time tₚₚ between adjacent downward peaks corresponds to the time during which a particle travels between the centers of adjacent constricted parts 33b. Note that, when all the distances between the centers of adjacent constricted parts 33b are the same, tₚₚ can be simply used for computation of a zeta potential. When the distances between the centers of adjacent constricted parts 33b differ from each other, the velocity at which a particle moves between the centers of adjacent constricted parts 33b can be calculated based on tₚₚ and the distances. Note that the moving time of a particle may be calculated by using a time t_{d} during which a particle passes through the constricted part 33b (L in FIG. 1D) instead of tₚₚ. As illustrated in FIG. 7A(b), the time between an intermediate value of the amount of a change in the downward direction of the ion current value and an intermediate value of the amount of a change in the upward direction from the downward direction peak value is the moving time t_{d} of a particle passing through the constricted part 33b. When the lengths L of the constricted parts 33b differ from each other, the velocity at which a particle moves in the constricted part 33b can be calculated from the length L and the moving time.
(3) FIG. 7B(c) is a graph illustrating a result of fitting a tₚₚ-m function by an exponential function by using a program. Accordingly, intercepts t_{carbo} and tₐₘᵢₙₒ of approximate curves obtained for an amino group-modified polystyrene particle that is a measuring target particle (Amino-modified PS) and a carboxyl group-modified polystyrene particle that is a reference particle (Carboxylated PS) were calculated. As illustrated in FIG. 7B(c), the time during which a particle travels from the center of the constricted part 33b on the most sample liquid supply channel side to the center of the adjacent constricted part 33b (m=1 in FIG. 7B(c)) was longer than that on the sample collection channel side. However, it was confirmed that the moving time of the particle was stabilized as the particle moved to the sample collection channel side. Note that the value at m=6 of the Carboxylated PS in FIG. 7B(c) is considered as some abnormal value though the cause thereof is unknown. When an intercept is found on an approximate curve, however, even if there is one abnormal value, this will less affect the measurement accuracy. This is an advantage of forming a plurality of constricted parts 33b.
(4) A commercially available zeta sizer was used to measure the zeta potential of a reference particle.
(5) A proportional equation indicated in FIG. 7B(d) was used to calculate individual zeta potentials of measuring target particles. FIG. 7C(e) illustrates the result thereof. Black circles of FIG. 7C(e) represent calculated zeta potentials of individual measuring target particles, and a line denoted as “zeta sizer—33.5 mV” represents an average value obtained when the commercially available zeta sizer was used to measure the measuring target particle (Amino-modified PS). It was confirmed that the zeta potentials of the measuring target particles calculated in accordance with the proportional equation illustrated in FIG. 7B(d) are distributed at the values substantially close to the measurement values resulted from the commercially available zeta sizer.

Further, FIG. 7C(f) is a graph illustrating a value of t_{d} described in (2) above. Note that, in FIG. 7C(f), depiction of the time t_{d} value for passage of the constricted part 33b on the most sample collection channel side is omitted. As is clear from the graph, it was confirmed that, as a particle moves to the sample collection channel side, the moving time of the particle is stabilized. Therefore, it is also possible to calculate the zeta potential of a particle by using t_{d} instead of tₚₚ.

It was confirmed from the above result that the motion trajectory of a particle immediately after the particle enters the constricted channel from the sample liquid supply channel is unstable and, as a result, the time or the like when the particle moves over a predetermined distance is also unstable. The method disclosed in Non-Patent Literature 2 calculates a zeta potential based on a change in ion current when a particle passes through a single nanopore. Thus, even with the same type of particles, the moving time or the like of a particle varies in accordance with an angle of the particle when entering the nanopore (for the same reason as when a particle enters the constricted part 33b No. 1 of FIG. 4A and FIG. 4B), and this causes variation to occur in the computation result of the zeta potential. In contrast, in the present application, it is possible to accurately calculate a zeta potential by measuring the ion current value with the use of the device having at least three or more constricted parts formed in the constricted channel through which a particle passes and calculating an approximate curve or using data of a portion where the moving time or the like of the particle is stable.

### INDUSTRIAL APPLICABILITY

Since the use of the device disclosed in the present application makes it possible to accurately calculate the time or the like where a single particle moves in a channel, it is possible to calculate a zeta potential based on the moving time or the like. Therefore, the device disclosed in the present application is useful in development of analysis apparatuses in the analysis instrument industry.

### LIST OF REFERENCES

1, 1a, 1b device
2 substrate
3 channel
31 sample liquid supply channel
32 sample collection channel
33 constricted channel
33a protrusion part
33b constricted part
33c groove
34 channel wall
7 measuring unit
8 analysis unit
8a computation unit
9 display unit
10 program memory
11 control unit
52 first electrode
53 lead
54 power supply
55 earth ground
62 second electrode
63 lead
64 earth ground
100 ion current measuring apparatus
110a zeta potential measuring apparatus
CL center line of the constricted channel
D length of the groove
H1 depth of the sample liquid supply channel
H2 depth of the constricted part
L length of the constricted part
M spacing between constricted parts
m distance between intermediate points of adjacent
constricted parts
S1, S2 particle
W width of the constricted part

1. A device used for measurement of ion current, the device comprising:
a substrate; and
a channel formed in the substrate,
wherein the channel includes
a sample liquid supply channel,
a sample collection channel, and
a constricted channel formed between the sample liquid supply channel and the sample collection channel, wherein
the constricted channel includes three or more constricted parts each formed with a protrusion part,
the three or more constricted parts are formed substantially straight in a direction from the sample liquid supply channel to the sample collection channel, and
when the width of each of the constricted parts is defined as 1, the spacing between adjacent constricted parts is 0.5 to 3.

2. The device according to claim 1, wherein the width of each of the constricted parts is such a width that allows a single particle contained in a sample liquid to pass through the width but does not allow two or more particles to pass through the width at once.

3. The device according to claim 1, wherein all sizes of the constricted parts are the same, and all spacings between the adjacent constricted parts are the same.

4. An ion current measuring apparatus comprising:
the device according to claim 1; and
a measuring unit that measures a change in ion current when a particle contained in a sample liquid passes through a constricted channel.

5. A zeta potential measuring apparatus comprising:
the ion current measuring apparatus according to claim 4; and
a computation unit that calculates a zeta potential of a particle based on a measured ion current value.

6. The zeta potential measuring apparatus according to claim 5, wherein the computation unit uses a time during which or a velocity at which a particle passes between adjacent constricted parts in the measured ion current value.

7. The zeta potential measuring apparatus according to claim 6 further comprising a storage unit that stores a zeta potential of a reference particle and a time during which or a velocity at which the reference particle passes between the adjacent constricted parts.

8. An ion current measuring method using an ion current measuring apparatus, wherein the ion current measuring apparatus includes a device and a measuring unit,
wherein the device includes
a substrate, and
a channel formed in the substrate,
wherein the channel includes
a sample liquid supply channel,
a sample collection channel, and
a constricted channel formed between the sample liquid supply channel and the sample collection channel, wherein
the constricted channel includes three or more constricted parts each formed with a protrusion part,
the three or more constricted parts are formed substantially straight in a direction from the sample liquid supply channel to the sample collection channel,
when the width of each of the constricted parts is defined as 1, the spacing between adjacent constricted parts is 0.5 to 3, and
wherein the measuring unit is capable of measuring a change in ion current when a particle contained in a sample liquid passes through the constricted channel,
the ion current measuring method comprising:
a particle motion step of causing a particle contained in the sample liquid supplied to the sample liquid supply channel to move toward the sample collection channel; and
a measuring step of measuring a change in ion current when the particle passes through the constricted channel.

9. A zeta potential measuring method for a sample, the zeta potential measuring method comprising:
a computation step of calculating a zeta potential of a particle based on an ion current value obtained by the ion current measuring method according to claim 8.

10. The zeta potential measuring method according to claim 9, wherein the computation step uses a time during which or a velocity at which a particle passes between adjacent constricted parts in the measured ion current value.

11. The device according to claim 2, wherein all sizes of the constricted parts are the same, and all spacings between the adjacent constricted parts are the same.

12. An ion current measuring apparatus comprising:
the device according to claim 2; and
a measuring unit that measures a change in ion current when a particle contained in a sample liquid passes through a constricted channel.

13. An ion current measuring apparatus comprising:
the device according to claim 3; and
a measuring unit that measures a change in ion current when a particle contained in a sample liquid passes through a constricted channel.

14. An ion current measuring apparatus comprising:
the device according to claim 11; and
a measuring unit that measures a change in ion current when a particle contained in a sample liquid passes through a constricted channel.

15. A zeta potential measuring apparatus comprising:
the ion current measuring apparatus according to claim 11; and
a computation unit that calculates a zeta potential of a particle based on a measured ion current value.

16. A zeta potential measuring apparatus comprising:
the ion current measuring apparatus according to claim 12; and
a computation unit that calculates a zeta potential of a particle based on a measured ion current value.

17. A zeta potential measuring apparatus comprising:
the ion current measuring apparatus according to claim 13; and
a computation unit that calculates a zeta potential of a particle based on a measured ion current value.

18. A zeta potential measuring apparatus comprising:
the ion current measuring apparatus according to claim 14; and
a computation unit that calculates a zeta potential of a particle based on a measured ion current value.

19. The zeta potential measuring apparatus according to claim 11, wherein the computation unit uses a time during which or a velocity at which a particle passes between adjacent constricted parts in the measured ion current value.

20. The zeta potential measuring apparatus according to claim 12, wherein the computation unit uses a time during which or a velocity at which a particle passes between adjacent constricted parts in the measured ion current value.
